(19) United States
(12) Patent Application Publication
(10) Pub. No.: US 2022/0374934 A1
(43) Pub. Date: Nov. 24, 2022

(54) PROBABILISTIC ADVERTISEMENT REVENUE ATTRIBUTION

(71) Applicant: Vungle, Inc., San Francisco, CA (US)

(72) Inventors: Dmitry Yudovsky, Los Angeles, CA (US); Benjamin Young, Thousand Oaks, CA (US); Andre Tutundjian, Studio City, CA (US); Paul Bowen, Seattle, WA (US)

(21) Appl. No.: 17/323,956

(22) Filed: May 18, 2021

(51) Int. Cl. G06Q 30/02

(52) U.S. Cl. CPC G06Q 30/0243; G06Q 30/0251; G06Q 30/0201; G06Q 30/0205

(57) ABSTRACT

Described are systems and methods that utilize ad campaign acquisition information and user profile data to probabilistically determine which users were acquired through which ad campaign. For example, a user probabilistic attribution score may be determined for each ad campaign for each user, and a user lifetime value may be allocated to different ad campaigns based at least in part on the determined probabilistic attribution scores.

### BACKGROUND

With the continued increase in mobile device usage and the availability to digital content, advertising is shifting from generic print to user specific and targeted digital advertising. However, this shift has resulted in advertisers having more difficulty developing targeted advertisements for the wide variety of consumers and their preferences and allocating advertising resources to the right advertising campaigns. In addition, with the recent increase in user privacy, traditional information indicating which users downloaded or installed applications in response to an advertisement campaign is often no longer available.

### BRIEF DESCRIPTION OF THE DRAWINGS

FIG. 1 is a block diagram of a system to generate probabilistic advertisement revenue allocation, in accordance with described implementations.

FIGS. 2A through 2D are block diagrams illustrating probabilistic attributions for different application users and different advertising campaigns for the application, in accordance with described implementations.

FIG. 3 is an example advertisement campaign probabilistic attribution process, in accordance with described implementations.

FIG. 4 is an example predicted return on advertisement spend process, in accordance with described implementations.

FIG. 5 is an example advertisement budget adjustment process, in accordance with described implementations.

FIG. 6 illustrates an example computing device, according to an implementation.

FIG. 7 illustrates an example configuration of components of a computing device, such as that illustrated in FIG. 6.

FIG. 8 is a pictorial diagram of an illustrative implementation of a server system that may be used for various implementations.

### DETAILED DESCRIPTION

Methods and systems are disclosed that provide probabilistic advertisement revenue allocation across multiple advertisement campaigns (“ad campaign”) without the need to have information as to which users obtained, installed, or otherwise accessed an item, such as an application, as a result of which advertisement campaign. With new user privacy measures, advertisers often no longer have a direct connection between advertisements and users that were acquired in response to an advertisement. Instead, advertisers now receive non-user identifiable ad campaign acquisition information indicating the number of users, but not user identifiable information, that were acquired in response to an advertisement of an ad campaign. The ad campaign acquisition information for each ad campaign of a plurality of ad campaigns may then be combined to produce a user acquisition distribution across all of the ad campaigns for the item being advertised. However, because the acquisition information and resulting user acquisition distribution does not include any user identifiable information, such information is insufficient to determine which users were acquired through which ad campaign.

As used herein, a user acquisition or acquired user refers to a user that has installed, downloaded, or otherwise accessed an item, such as an application. For example, if a user downloads a trial version of an application, the user may be referred to herein as an acquired user. An item, as used herein, refers to any physical item, digital item, physical service, or digital service that may be downloaded, obtained, used, or otherwise accessed by a user. As an example, an item may be a digital application that is downloaded onto a user device.

In addition, user profile data corresponding to actual user acquisitions is also accessible. However, while such information does include user identifiable information for users that were acquired (e.g., users that downloaded or installed the application), such as a user identifier, device identifier, operating system, etc., the user profile data does not include any indication of whether the user was acquired in response to an advertisement of an ad campaign or acquired independent of an ad campaign (referred to herein as an organic acquisition).

Because there is no direct link between the two sets of data, ad campaign acquisition information and user profile data, it is not possible to deterministically assess which users were acquired through which ad campaigns.

The disclosed implementations utilize the ad campaign acquisition information and user profile data to probabilistically determine which users were acquired through which ad campaign. For example, a user probabilistic attribution score may be determined for each ad campaign for each user, the user probabilistic attribution score indicating a probability that the user was acquired by the respective campaign.

In addition, to determine the return realized by an ad campaign, a user lifetime value (“LTV”) may be computed for each acquired user, as discussed further below, and a percentage of the user LTV allocated to each of the different ad campaigns to indicate a return on ad campaign spend (“ROAS”). Such information about each ad campaign may then be used to reallocate resources and/or optimize one or more ad campaigns.

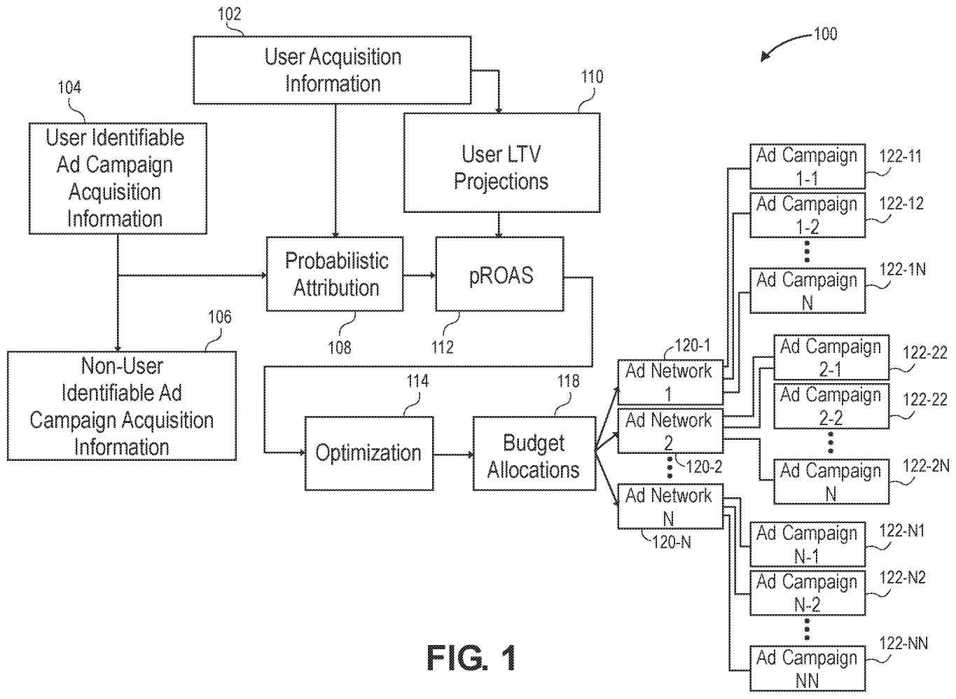

FIG. 1 is a block diagram of a system 100 to generate probabilistic advertisement revenue allocation, in accordance with described implementations.

As illustrated, the system 100 receives non-user identifiable ad campaign acquisition information 106 indicative of a number of user acquisitions in response to presented advertisements from different ad campaigns 122. Such information may be received from a device operating system provider, such as APPLE for devices like the IPHONE, often referred to as ad network data. Such ad campaign acquisition information 106 may indicate, among other non-user identifiable information, an ad campaign identifier for which one or more advertisements were presented to users via different user devices, an identifier of a host application through which the advertisement was presented, a conversion value indicative of a value of conversions or installs resulting from different advertisements of the ad campaign, etc.

A host application, as used herein, refers to an application that is already installed, operating, or otherwise accessible on a user device through which one or more advertisements are presented. For example, a user may download and install on a user device a host application, such as a game, and, while the host application is executing on the user device (e.g., while the user is playing the game), one or more advertisements of one or more ad campaigns may be presented to the user through the host application.

In some implementations, the system 100 may also receive user identifiable ad campaign acquisition information 104. For example, some users may select to allow user identifiable information to be shared with the system 100. For those users, user identifiable ad campaign acquisition information 104 may be received by the system 100 that indicates, for a particular user, what ad campaign was presented to the user and whether the user was acquired in response to the ad campaign.

In addition to receiving non-user identifiable ad campaign acquisition information 106 and user identifiable ad campaign acquisition information 104, the system 100 also receives user acquisition information 102. User acquisition information, which is independent of and devoid of any ad campaign acquisition information, indicates a user identifier for different users that have downloaded, installed or otherwise accessed the advertised item.

Based on the non-user identifiable ad campaign acquisition information 106, the user identifiable ad campaign acquisition information 104, and the user acquisition information 102, the system 100 generates probabilistic attributions 108 for each ad campaign, as discussed further below. As discussed further below, the probabilistic attribution indicates for each ad campaign a likelihood that a user was acquired in response to the ad campaign.

In addition, the system may determine for each user indicated in the user acquisition information 102, a user lifetime value (“LTV”) 110 for the user. A variety of techniques may be used to compute user LTV, which is a projection of the net profit attributed to the ongoing relationship between the user and the provider of the application installed by the user.

Based on the probabilistic attributions 108 and computed user LTVs 110, the system may compute a predicted return on advertisement spend 112 (“pROAS”). For example, the system 100 may maintain or obtain the cost spent or projected to be spent (i.e., budget) on an advertisement campaign and compute, based on the advertisement spend, the probabilistic attributions, and the computed user LTVs a pROAS for each advertisement campaign 122 as the product of those three sets of values. For advertisement campaigns having a higher probabilistic attribution score 108, a larger percentage of the user LTV projection 110 will be applied to that ad campaign, as discussed further below.

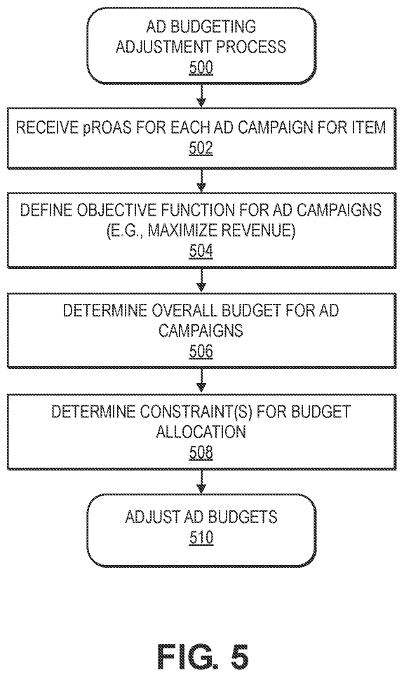

In some implementations, the system 100 may also utilize the pROAS computed for a variety of ad campaigns 122 for an item to provide optimization 114 to the advertiser. For example, optimization for each campaign indicating different geographic areas into which to focus an ad campaign, the types of user devices to which an ad campaign should be delivered, etc., may be optimized. Still further, in some implementations, an advertising budget for an item may be adjusted or re-allocated 118 based on the pROAS computed for one or more ad campaigns for an item. Reallocation of budgets for ad campaigns may be within the same ad network 120 and/or across ad networks 120, for example as discussed further below with respect to FIG. 5. For example, budgets may be re-allocated across different ad campaigns 122-11, 122-12, through 122-1N that are presented for the same item to ad network 1 120-1. In other examples, the budget for a single ad campaign 122 of one or more ad campaigns for the item may be re-allocated to different advertising networks 120-1, 120-2, through 120-N through which advertisements of the ad campaign are presented.

One or more ad campaigns 122 for an item may be performed on different ad networks. For example, multiple ad campaigns 122-11, 122-12, through 122-1N may be performed on a first ad network 120-1, ad campaigns 122-21, 122-22, through 122-2N may be performed on a second network 120-2, and ad campaigns 122-N1, 122-N2, through 122-NN may be performed on an Nth network. Likewise, some of the ad campaigns performed on the different ad networks may be the same or different. For example, ad campaign 122-12 may be the same as ad campaign 122-22.

As discussed, the disclosed implementations provide a technical improvement over existing systems by predicting which advertising campaigns acquired which different users without discrete information that indicates which users received which advertising campaigns.

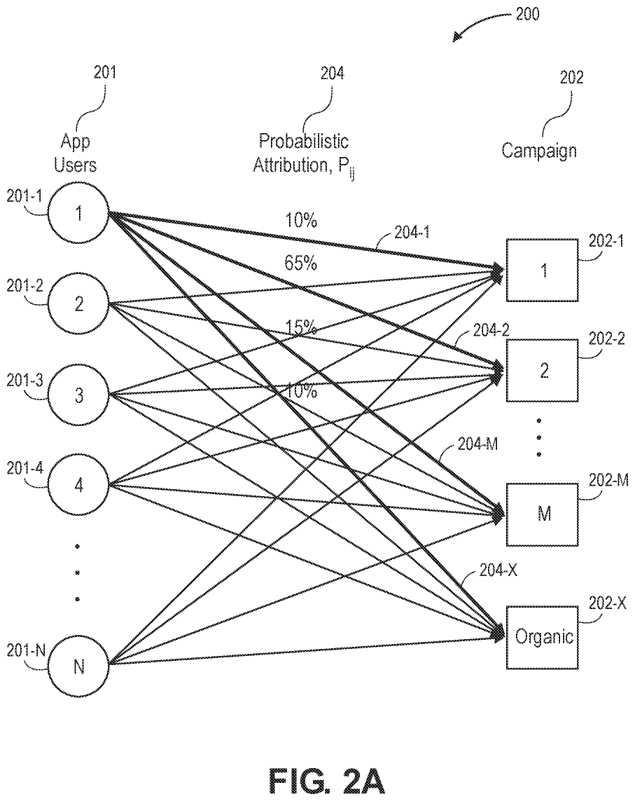

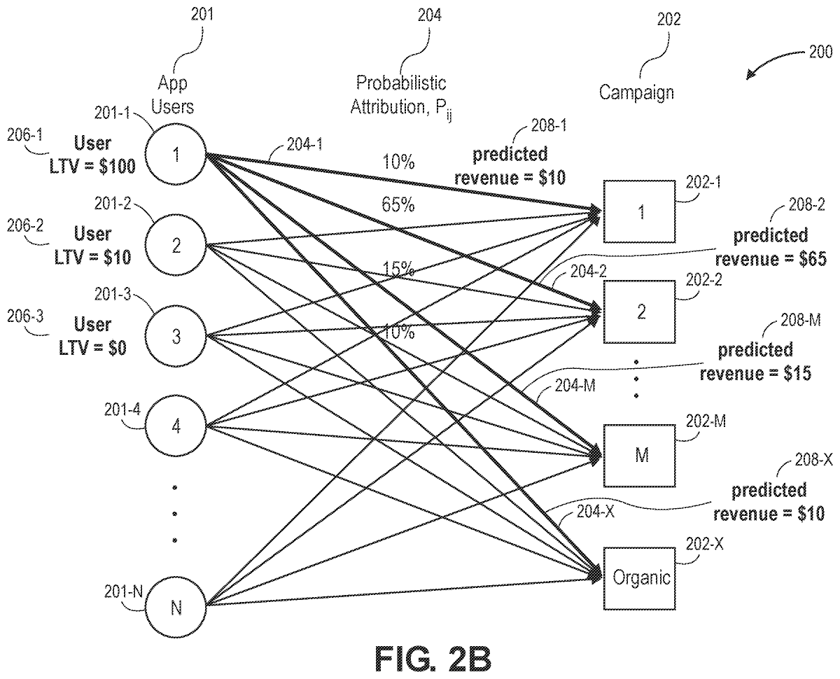

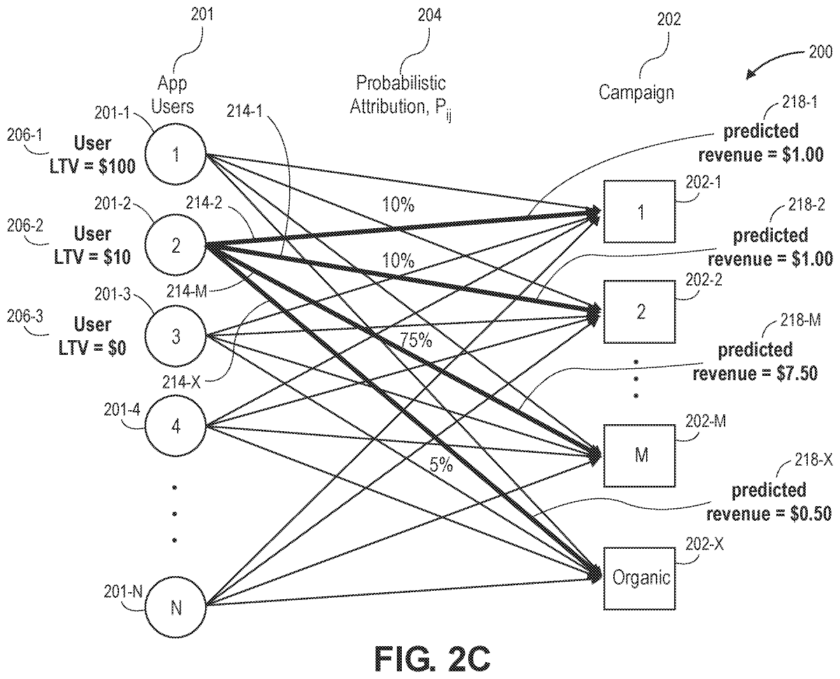

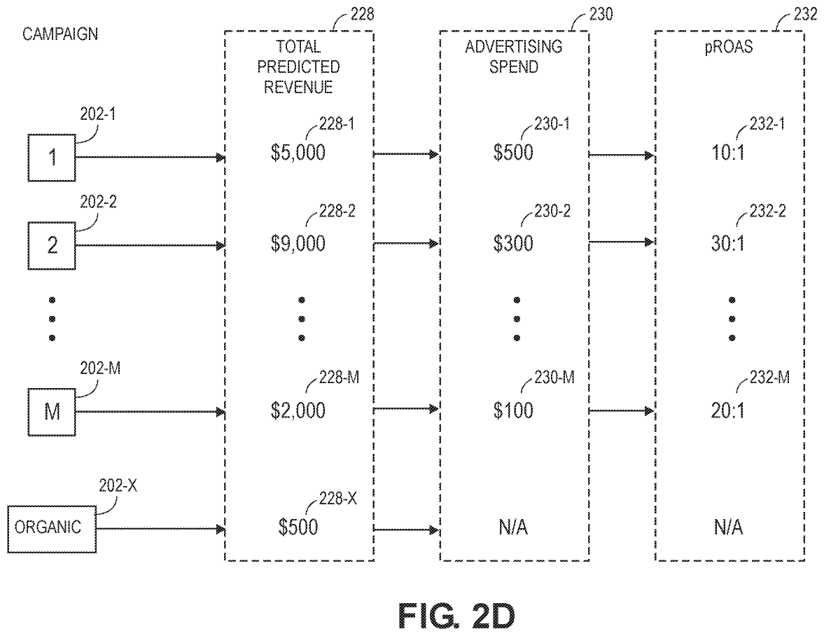

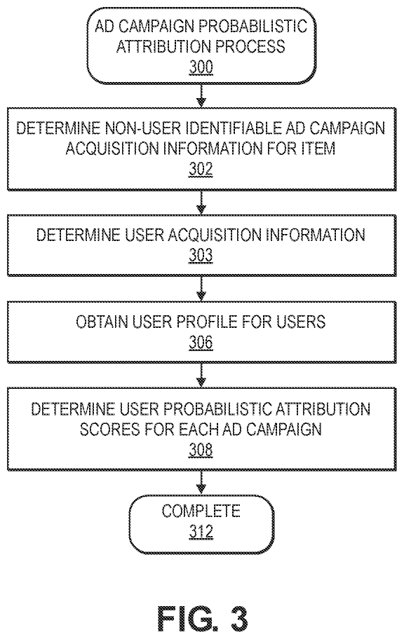

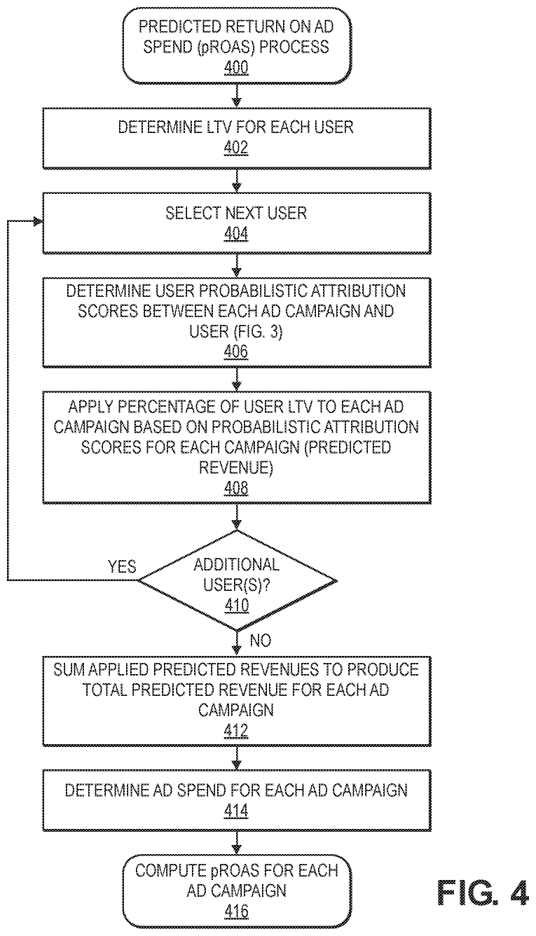

FIG. 2A is a block diagram 200 illustrating probabilistic attributions 204 of a plurality of users 201 with respect to a plurality of advertisement campaigns 202, in accordance with described implementations. An example probabilistic attribution process for determining probabilistic attributions 204 is discussed further below with respect to FIG. 3.

As illustrated, a probabilistic attribution score for each user 201-1, 201-2, 201-3, 201-4, through 201-N with respect to each advertisement campaign 202-1, 202-2, through 202-M and an organic acquisition 202-X is determined in accordance with the example process 300 (FIG. 3). For example, for a first user 201-1, it is determined that the installation of the application by the first user has a 10% probability 204-1 as having occurred in response to the first user 201-1 being presented with an advertisement from a first ad campaign 202-1, a 65% probability 204-2 as having occurred in response to the first user 201-1 being presented with an advertisement from a second ad campaign 202-2, a 15% probability 204-M as having occurred in response to the first user 201-1 being presented with an advertisement from an Mth ad campaign 202-M, and a 10% probability 204-X as having occurred organically 202-X, i.e., independent of an ad campaign 202 for the item.

As illustrated, in some implementations, the different probability scores 204 determined for a user and each of the ad campaigns 202 may sum to unity. In other implementations, the sum of the probability scores for a user may not sum to unity.

Referring now to FIG. 2B, a predicted revenue 208 may be computed or allocated to each ad campaign based on the determined user LTV values 206 for each user and the probabilistic attribution score 204 determined between each user 201 and each ad campaign 202. In the illustrated example, it is determined that the first user 201-1 has a user LTV of $100 206-1. Based on the probabilistic attribution scores 204, the user LTV is distributed to each of the different ad campaigns. For example, the product of the user LTV and a probabilistic attribution score between a user and an ad campaign may be computed to determine the portion of the user LTV to allocate to each ad campaign. In the illustrated example, with a probabilistic attribution score 204-1 of 10% between the first user and the first ad campaign and a user LTV 206-1 of $100 for the first user, a first predicted revenue 208-1 of $10 is determined and allocated to the first ad campaign 202-1. Likewise, a second predicted revenue 208-2 of $65 is determined and allocated to the second ad campaign 202-2 as a result of the product of the second probabilistic attribution score 204-2 of 65% and the determined user LTV of $100 for the first user 201-1, an Mth predicted revenue 208-M of $15 is determined and allocated to the Mth ad campaign 202-M as a result of the product of the Mth probabilistic attribution score 204-M of 15% and the determined user LTV of $100 for the first user 201-1, and a predicted revenue 208-X of $10 is determined and allocated to the organic acquisition 202-X as a result of the product of the Xth probabilistic attribution score 204-X of 10% and the determined user LTV of $100 for the first user 201-1.

As will be appreciated, different probabilistic attribution scores and different user LTVs will result in different predicted revenues being allocated to each ad campaign. For example, referring now to FIG. 2C, for the second user 201-2, who has a user LTV 206-2 of $10, assuming it is determined that the probabilistic attribution scores 214-1, 214-2, 214-M, and 214-X between the second user and the different ad campaigns are 10% for the first ad campaign 202-1, 10% for the second ad campaign 202-2, 75% for the Mth ad campaign, and 5% for organic acquisitions, the predicted revenue 218-1 for the first ad campaign is $1.00, the predicted revenue 218-2 for the second ad campaign is $1.00, the predicted revenue 218-M for the Mth ad campaign is $7.50, and the predicted revenue 218-X for organic acquisitions 202-X is $0.50.

Determining the predicted revenue for each user and each ad campaign may be done between each user and each ad campaign and a total predicted revenue computed for each ad campaign as the sum of the predicted revenue from each user allocated to that ad campaign. For example, if there were only the first user and the second user, the first ad campaign 202-1 would have a total predicted revenue of $11.00, the second ad campaign 202-2 would have a total predicted revenue of $66.00, the Mth ad campaign 202-M would have a total predicted revenue of $17.50, and the organic acquisition would be allocated $10.50.

Referring now to FIG. 2D and continuing with the above example, once the predicted revenue is determined between each user and each advertising campaign, a total predicted revenue 228 may be computed for each ad campaign as the sum of the predicted revenues determined between each user and each ad campaign. In the illustrated example, it may be determined that the total predicted revenue 228-1 resulting from all the users 201-1 through 201-N for the first ad campaign 202-1 is determined to be $5,000, the total predicted revenue 228-2 for the second ad campaign 202-2 is determined to be $9,000, the total predicted revenue 228-M for the Mth ad campaign 202-M is determined to be $2,000, and the total predicted revenue 228-X resulting from organic acquisitions 202-X is determined to be $500.

Likewise, an advertising spend 230 may be allocated among the different advertising campaigns, as may be specified by the advertiser or otherwise determined. In the illustrated example, the advertising spend 230 for advertising an item is allocated such that a first advertising spend 230-1 of $500 is allocated to the first advertising campaign 202-1, a second advertising spend 230-2 of $300 is allocated to the second advertising campaign 202-2, and an Mth advertising spend 230-M of $100 is allocated to the Mth advertising campaign 202-M. It will be appreciated that no advertising spend is allocated to the organic acquisitions because those are acquisitions that are independent of an ad campaign.

Based on the total predicted revenue 228 determined for each ad campaign 202 and the portion of the advertising spend 230 allocated to each advertising campaign, a pROAS 232 may be computed for each ad campaign 202.

As discussed, the pROAS may be utilized to optimize the advertising campaigns, for example to re-adjust advertising budgets to different ad campaigns, as an indicator to adjust the device type, location, etc., to which ads from an ad campaign are to be directed, etc. In the illustrated example, the first ad campaign 202-1 is determined to have a pROAS with a 10:1 ratio 232-1, the second ad campaign 202-2 is determined to have a pROAS with a 30:1 ratio 232-2, and the Mth ad campaign 202-M is determined to have a pROAS with a 20:1 ratio. Because the Mth ad campaign 202-M has a pROAS of 20:1 232-M and the first ad campaign 202-1 has a 10:1 pROAS 232-1, it may be determined to reallocate budget from the first ad campaign 202-1 to the Mth ad campaign 202-M because of the higher pROAS.

FIG. 3 is an example advertisement campaign probabilistic attribution process 300, in accordance with described implementations.

The example process 300 begins by determining or receiving non-user identifiable ad campaign acquisition information for an item, as in 302. As discussed above, multiple ad campaigns may be performed to advertise an item through different sources and non-user identifiable ad campaign acquisition information may be determined or received for those ad campaigns. As discussed above, the non-user identifiable ad campaign acquisition information may provide acquisition information resulting from different ad presentations of different ad campaigns, but does not include any user-identifiable information. For example, non-user identifiable ad campaign acquisition information may include, but is not limited to, a campaign identifier for which one or more advertisements were presented to users via different user devices, an identifier of a host application through which the advertisement was presented, a conversion value indicative of a value of conversions or installs resulting from different advertisements of the ad campaign, etc. Such information may be received, for example, for a device platform system, management system, etc.

In some implementations, the conversion value may be set according to a specified structure that provides information about the related advertisement or item being advertised. For example, in some implementations, the conversion value may be a 6 bit value, thereby providing sixty-four different values that may be set as the conversion value. Accordingly, the conversion value may be set according to a schedule or plan to indicate information about the ad campaign acquisition information. For example, a first conversion value may specify that the ad campaign was viewed, a second conversion value may specify that the item being advertised through the ad campaign was accessed, a third conversion value may specify that the item being advertised was downloaded, a fourth conversion value may specify that the item being advertised was accessed on the device after download, a fifth conversion value may specify that the item being advertised was accessed and a trial was started, a sixth conversion value may specify that the item being advertised was accessed, a purchase was made, etc.

In some implementations, the conversion value may not be included in all received non-user identifiable information. For example, the provider of non-user identifiable information may withhold the conversion value if a total number of users is below a threshold. In such an instance, the conversion value may enable determination of the user that accessed the advertisement and/or item. In such instances, the disclosed implementations may utilize other information, as discussed below, to account for the omitted conversion values in some of the non-user identifiable information, and generate probabilistic attribution scores.

In addition, the example process may also determine or receive user acquisition information for the item, as in 303. For example, the advertiser and/or the provider of an advertised application (an item) may receive user information each time a user installs an application. However, such information is devoid of any ad campaign information.

User profiles for each user indicated in the user acquisition information may also be obtained, as in 306. The user profiles may indicate, among other information, purchase history of each user, application use history for other apps purchased/downloaded by each user, user locations, demographics, age, gender, etc.

Based on the app being advertised, the user profiles, and the ad campaign acquisition information, a probabilistic attribution score is determined between each user and each ad campaign for the item, as in 308. For example, the user profiles and ad campaign information for each ad campaign (e.g., target audience, ad duration, advertised app genre, advertised app theme, etc.) may be provided to a trained machine learning model and the machine learning model may determine, for each ad campaign and user profile combination, a probabilistic attribution score. As a result, a probabilistic attribution score may be computed for each combination of user and ad campaign.

Once probabilistic attribution scores between the users and each ad campaign have been determined, the example process 300 completes, as in 312.

FIG. 4 is an example predicted return on advertisement spend process 400, in accordance with described implementations.

The example process 400 begins by determining a user LTV for each user indicated in the user acquisition information, as in 402. Any of a variety of techniques may be utilized to determine user LTV. For example, the Pareto/NBD model may be utilized to compute user LTV. Other such models may likewise be used.

A user of the one or more users indicated in the user acquisition information is then selected, as in 404, and user probabilistic attribution scores are determined between the selected user and each ad campaign for the item, as in 406. Determination of the user probabilistic attribution scores between the user and each of the ad campaigns is discussed above with respect to FIG. 3.

A percentage of the user LTV is then applied to each ad campaign based on the probabilistic attribution score determined between the user and the respective ad campaign, as in 408. The percentage of the user LTV applied to an ad campaign is referred to herein as a predicted revenue from that user for that ad campaign. As discussed above, when there are multiple ad campaigns, the user LTV is distributed among the different ad campaigns based on the probabilistic attribution scores determined for each ad campaign for that user.

After applying a percentage of the user LTV to each ad campaign, a determination is made as to whether additional users are indicated in the user acquisition information for which the example process 400 is to be performed, as in 410.

If it is determined that additional users remain, the example process 400 returns to block 404 and continues. If it is determined that the user LTV for each user has been allocated across the different ad campaigns for an item according to the probabilistic attribution scores determined between those users and ad campaigns, for each ad campaign, the applied predicted revenues for each user are summed to compute a total predicted revenue for the ad campaign, as in 412.

An ad spend may also be determined or obtained for each ad campaign, as in 414. For example, the amount spent on each ad campaign may be periodically provided by an advertiser or otherwise known to the example process 400.

Finally, for each ad campaign, a pROAS is computed based at least in part on the total predicted revenue computed for the ad campaign and the ad spend for that ad campaign, as in 416. As discussed above, the pROAS may be computed as a ratio between the total predicted revenue and the ad spend for the ad campaign. In other implementations, the pROAS may be computed as a multiple of the ad spend, a percentage of the ad spend, etc.

While the above examples describe computation of a pROAS for each ad campaign, in some implementations, the disclosed implementations may compute a predicted return on investment (“pROI”). For example, the pROI for an ad campaign may be computed as the difference between the predicted total revenue for the ad campaign and the ad spend for the advertisement divided by the ad spend for the ad campaign.

FIG. 5 is an example advertisement budget adjustment process 500, in accordance with described implementations.

The example process 500 begins by receiving or obtaining the pROAS determined for each ad campaign for an item, as in 502. As discussed above, multiple ad campaigns may be performed for a same item, the campaigns existing on the same or different ad networks.

An objective function for adjusting the ad budget may also be defined, as in 504. The objective function may vary for different items, different advertisers, different times of year, etc. For example, one advertiser may specify an object function of exposure of users to the ad campaigns while another advertiser may specify an objective function of revenue maximization from the ad campaigns.

In addition, an overall budget for all ad campaigns corresponding to the item, or at least all ad campaigns for which budget adjustments are to be made, may be determined or obtained, as in 506. For example, an advertiser may specify a single total budget for multiple different ad campaigns for an item. The multiple different ad campaigns may all be on a same ad network or may span multiple ad networks.

Finally, one or more constraints may be determined for budget allocation of the overall budget across the multiple ad campaigns, as in 508. The one or more constraints may specify any of a variety of constraints that are to be adhered to as part of the example process 500. For example, constraints may include, but are not limited to, minimum revenue for an ad campaign, potential users that will access the ad campaign, geographic location, duration of ad campaign, cost per advertisement for the ad campaign, etc.

Based on the pROAS determined for each ad campaign for the item and the overall budget specified for the multiple ad campaigns, the overall allocation of the budget across the ad campaigns is adjusted to optimize the advertising spend across the ad campaigns in accordance with the optimization function and while complying with the constraints, as in 510.

The example process 500 may be performed periodically (e.g., hourly, daily, weekly) for each ad campaign for an item across all networks, periodically for each ad campaign within a single ad network, etc. Likewise, in some implementations, rather than considering and adjusting budgets between individual ad campaigns, in some implementations, the example process 500 may be applied at the ad network level and portions of the overall budget allocated across the different ad networks. In such an implementation, the example process 500 may then again be performed at each ad network to determine or adjust allocation of the allocated portion of the overall budget to that ad network among each ad campaign performed on that ad network for the item.

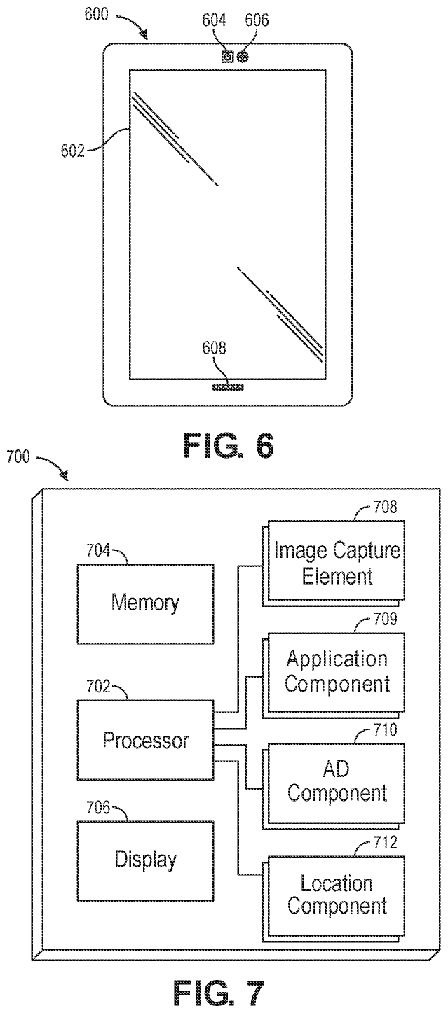

FIG. 6 illustrates an example user device 600 that can be used in accordance with various implementations described herein. In this example, the user device 600 includes a display 602 and optionally at least one input component 604, such as a camera, on a same and/or opposite side of the device as the display 602. The user device 600 may also include an audio transducer, such as a speaker 606, and optionally a microphone 608. Generally, the user device 600 may have any form of input/output components that allow a user to interact with the user device 600. For example, the various input components for enabling user interaction with the device may include a touch-based display 602 (e.g., resistive, capacitive), camera, microphone, global positioning system (GPS), compass, accelerometer, or any combination thereof. One or more of these input components may be included on a device or otherwise in communication with the device. Various other input components and combinations of input components can be used as well within the scope of the various implementations as should be apparent in light of the teachings and suggestions contained herein.

In order to provide the various functionality described herein, FIG. 7 illustrates an example set of basic components 700 of a user device 600, such as the user device 600 described with respect to FIG. 6 and discussed herein. In this example, the device includes at least one central processor 702 for executing instructions that can be stored in at least one memory device or element 704. As would be apparent to one of ordinary skill in the art, the device can include many types of memory, data storage or computer-readable storage media, such as a first data storage for program instruction for execution by the processor 702. Removable storage memory can be available for sharing information with other devices, etc. The device typically will include some type of display 706, such as a touch-based display, electronic ink (e-ink), organic light emitting diode (OLED), or liquid crystal display (LCD).

The device in many implementations will include at least one image capture element 708, such as one or more cameras that are able to image objects in the vicinity of the device. An image capture element can include, or be based at least in part upon, any appropriate technology, such as a CCD or CMOS image capture element having a determined resolution, focal range, viewable area, and capture rate. The device can include at least one ad component 710 for performing the process of sending ad requests and/or application initiation notifications, providing user and/or device information, etc. For example, the user device may be in constant or intermittent communication with a remote computing resource and may exchange information, such as selected advertisements, user device information, user information, application information, engagement information, conditions, etc. The device 700 may also include an application component 709 that enables execution and/or monitoring of applications executing on the device. In some implementations, the application component 709 may collect usage information about applications and provide that information to an ad server system, a machine learning system, advertisers, attributers, etc.

The device also can include at least one location component 712, such as GPS, NFC location tracking or Wi-Fi location monitoring. Location information obtained by the location component 712 may be used with the various implementations discussed herein as a factor in generating advertisements, targeting advertisements, etc.

The example user device may also include at least one additional input device able to receive conventional input from a user. This conventional input can include, for example, a push button, touch pad, touch-based display, wheel, joystick, keyboard, mouse, trackball, keypad or any other such device or element whereby a user can input a command to the device. These I/O devices could be connected by a wireless, infrared, Bluetooth, or other link as well in some implementations.

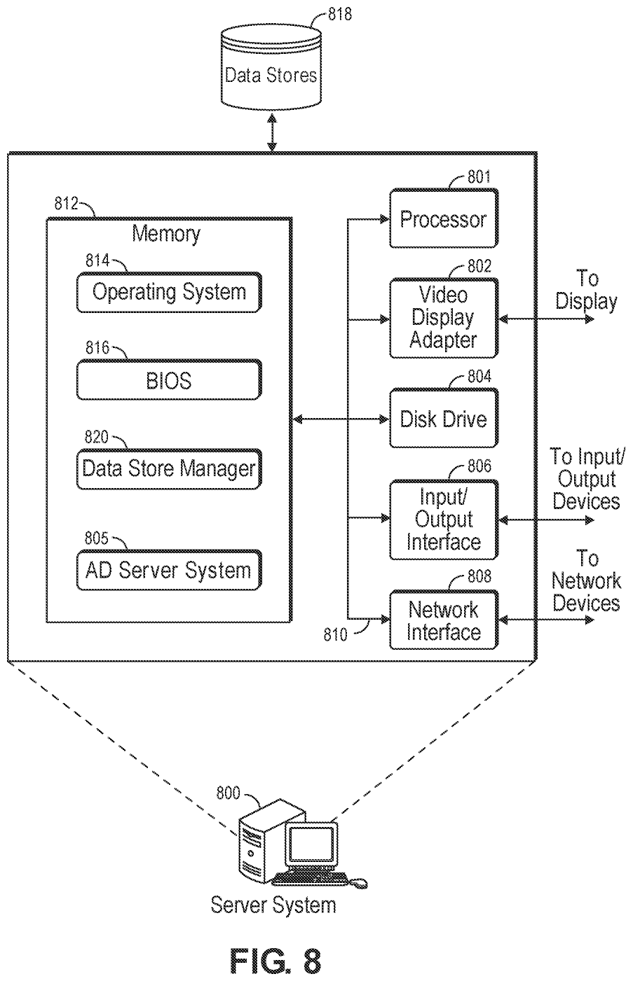

FIG. 8 is a pictorial diagram of an illustrative implementation of a server system 800, such as a remote computing resource, that may be used with one or more of the implementations described herein. The server system 800 may include a processor 801, such as one or more redundant processors, a video display adapter 802, a disk drive 804, an input/output interface 806, a network interface 808, and a memory 812. The processor 801, the video display adapter 802, the disk drive 804, the input/output interface 806, the network interface 808, and the memory 812 may be communicatively coupled to each other by a communication bus 810.

The video display adapter 802 provides display signals to a local display permitting an operator of the server system 800 to monitor and configure operation of the server system 800. The input/output interface 806 likewise communicates with external input/output devices, such as a mouse, keyboard, scanner, or other input and output devices that can be operated by an operator of the server system 800. The network interface 808 includes hardware, software, or any combination thereof, to communicate with other computing devices. For example, the network interface 808 may be configured to provide communications between the server system 800 and other computing devices, such as the user device 600.

The memory 812 generally comprises random access memory (RAM), read-only memory (ROM), flash memory, and/or other volatile or permanent memory. The memory 812 is shown storing an operating system 814 for controlling the operation of the server system 800. A binary input/output system (BIOS) 816 for controlling the low-level operation of the server system 800 is also stored in the memory 812.

The memory 812 additionally stores program code and data for providing network services that allow user devices 600 and external sources to exchange information and data files with the server system 800. The memory also stores a data store manager application 820 to facilitate data exchange and mapping between the data store 818, ad server system 805, user devices, such as the user device 600, external sources, etc.

As used herein, the term “data store” refers to any device or combination of devices capable of storing, accessing and retrieving data, which may include any combination and number of data servers, databases, data storage devices and data storage media, in any standard, distributed or clustered environment. The server system 800 can include any appropriate hardware and software for integrating with the data store 818 as needed to execute aspects of one or more applications for the user device 600, the external sources and/or the ad server system 805. The server system 800 provides access control services in cooperation with the data store 818 and is able to generate content such as advertisements.

The data store 818 can include several separate data tables, databases or other data storage mechanisms and media for storing data relating to a particular aspect. For example, the data store 818 illustrated includes user profiles and/or ad campaign information for different ad campaigns. Templates, machine learned user models, advertisements, and/or other information may likewise be stored in the data store.

It should be understood that there can be many other aspects that may be stored in the data store 818, which can be stored in any of the above listed mechanisms as appropriate or in additional mechanisms of any of the data stores. The data store 818 may be operable, through logic associated therewith, to receive instructions from the server system 800 and obtain, update or otherwise process data in response thereto.

The memory 812 may also include the ad server system 805. The ad server system 805 may be executable by the processor 801 to implement one or more of the functions of the server system 800. In one implementation, the ad server system 805 may represent instructions embodied in one or more software programs stored in the memory 812. In another implementation, the ad server system 805 can represent hardware, software instructions, or a combination thereof. The ad server system 805 may perform some or all of the implementations discussed herein, alone or in combination with other devices, such as the user device 600.

The server system 800, in one implementation, is a distributed environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 8. Thus, the depiction in FIG. 8 should be taken as being illustrative in nature and not limiting to the scope of the disclosure.

The concepts disclosed herein may be applied within a number of different devices and computer systems, including, for example, general-purpose computing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the art should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk and/or other media. In addition, components of one or more of the modules and engines may be implemented in firmware or hardware.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors; and
a memory storing program instructions that when executed by the one or more processors cause the one or more processors to at least:
determine an ad campaign acquisition information for each of a plurality of advertisement campaigns for an application, wherein the ad campaign acquisition information is devoid of user information;
for each user of a plurality of users:
obtain a user profile of the user;
determine, for each of the plurality of advertisement campaigns and based at least in part on the user profile and the ad campaign acquisition information, a user probabilistic attribution score, the user probabilistic attribution score indicative of a probability that the user obtained the application in response to an advertisement from the respective advertisement campaign;
determine a user lifetime value (“user LTV”) for the user; and
apply, to each of the plurality of advertisement campaigns, at least a portion of the user LTV based at least in part on the user probabilistic attribution score determined for the respective advertisement campaign; and
produce, for each of the plurality of advertisement campaigns, a predicted return on an advertisement campaign spend as a sum of each of the applied portion of the user LTV of each of the plurality of users.

2. The computing system of claim 1, wherein the program instructions when executed by the one or more processors to determine the user probabilistic attribution score, further include instructions that when executed by the one or more processors further cause the one or more processors to at least:
determine the user probabilistic attribution score based at least in part on the user profile, the ad campaign acquisition information, and a conversion value.

3. The computing system of claim 2, wherein the conversion value is received in response to a user obtaining the application.

4. The computing system of claim 1, wherein the user profile of the user indicates one or more of a location of the user, a browse history of the user, or an activity history of the user.

5. The computing system of claim 1, wherein at least a portion of the user LTV is allocated to organic acquisitions indicative of users that obtained the application independent of an advertisement of an advertisement campaign of the plurality of advertisement campaigns.

6. A computer-implemented method, comprising:
determining a user acquisition information for each of the plurality of advertisement campaigns corresponding to an item, the user acquisition information indicating users that acquired the item but devoid of ad campaign information;
determining for an advertisement campaign of the plurality of advertisement campaigns and based at least in part on the user acquisition information, a user probabilistic attribution score indicative of a probability that a user was acquired in response to an advertisement from the advertisement campaign;
determining a user lifetime value (“user LTV”) for the user; and
applying, to the advertisement campaign, at least a portion of the user LTV based at least in part on the user probabilistic attribution score determined for the advertisement campaign.

7. The computer-implemented method of claim 6, further comprising:
determining for the advertisement campaign, a second user probabilistic attribution score indicative of a second probability that a second user was acquired in response to an advertisement from the advertisement campaign;
determining a second user LTV for the second user; and
applying to the advertisement campaign a second at least a portion of the second user LTV based at least in part on the second user probabilistic attribution score.

8. The computer-implemented method of claim 7, further comprising:
producing, for the advertisement campaign, a predicted return on the advertisement campaign as a sum of at least the at least a portion and the second at least a portion.

9. The computer-implemented method of claim 6, further comprising:
determining a user profile for a user of the indicated users; and
wherein the user probabilistic attribution score is determined based at least in part on the user profile and the user acquisition information.

10. The computer-implemented method of claim 9, wherein the user profile of the user indicates one or more of a location of the user, a browse history of the user, or an activity history of the user.

11. The computer-implemented method of claim 6, further comprising:
receiving ad campaign acquisition information that indicates a number of users acquired through the advertisement campaign, but is devoid of user identifiable information; and
wherein the user probabilistic attribution score is further based at least in part on the ad campaign acquisition information.

12. The computer-implemented method of claim 6, wherein at least a portion of the user LTV is allocated to organic acquisitions indicative of users that were acquired independent of an advertisement of an advertisement campaign of the plurality of advertisement campaigns.

13. The computer-implemented method of claim 6, further comprising:
receiving, in response to the user acquiring the item, a conversion value; and
wherein the user probabilistic attribution score is further determined based at least in part on the conversion value.

14. The computer-implemented method of claim 13, wherein the conversion value is received from a third party.

15. The computer-implemented method of claim 6, further comprising:
recommending, based at least in part on the portion of the user LTV, an adjustment to at least one of the advertisement campaign or a second advertisement campaign of the plurality of advertisement campaigns.

16. A non-transitory computer-readable storage medium storing instruction that, when executed by at least one processor of a computing system, cause the computing system to at least:
receive ad campaign acquisition information indicative of a distribution of acquired users among each of a plurality of advertisement campaigns for an item, wherein the ad campaign acquisition information does not indicate any user identifiable information;
receive user acquisition information indicating a plurality of users that have obtained the item during a period of time, wherein the user acquisition information does not indicate any advertisement campaign information;
for each user of the plurality of users:
determine, for each of the plurality of advertisement campaigns and based at least in part on the user acquisition information and the ad campaign acquisition information, a user probabilistic attribution score, the user probabilistic attribution score indicative of a probability that the user obtained the item in response to an advertisement from the respective advertisement campaign;
determine a user lifetime value (“user LTV”) for the user; and
apply, to each of the plurality of advertisement campaigns, at least a portion of the user LTV based at least in part on the user probabilistic attribution score determined for the respective advertisement campaign; and
produce, for each of the plurality of advertisement campaigns, a predicted return on an advertisement campaign spend as a sum of each applied portion of the user LTV of each of the plurality of users.

17. The non-transitory computer-readable storage medium of claim 16, wherein the instructions, when executed by the at least one processor, further cause the at least one processor to determine the user probabilistic attribution score based at least in part on a user profile of a user, the user acquisition information, and the ad campaign acquisition information.

18. The non-transitory computer-readable storage medium of claim 16, wherein the instructions, when executed by the at least one processor, further cause the at least one processor to determine the user probabilistic attribution score based at least in part on a conversion value.

19. The non-transitory computer-readable storage medium of claim 18, wherein the conversion value is received in response to a user obtaining the item.

20. The non-transitory computer-readable storage medium of claim 16, wherein the instructions further cause the computing system to at least:
recommend, based at least in part on the predicted return on the advertisement campaign spend produced for each of the plurality of advertisement campaigns, an adjustment to at least one of the plurality of advertisement campaigns.
